(19) United States
(12) Patent Application Publication
(10) Pub. No.: US 2020/0079562 A1
(43) Pub. Date: Mar. 12, 2020

(54) Carrier With Reconfigurable Partition

(71) Applicant: Graphic Packaging International, LLC, Atlanta, GA (US)

(72) Inventor: John Murdick Holley, JR., Lawrenceville, GA (US)

(21) Appl. No.: 16/543,955

(22) Filed: Aug. 19, 2019

Related U.S. Application Data
(60) Provisional application No. 62/727,695, filed on Sep. 6, 2018.

(51) Int. Cl. B65D 71/58; B31B 50/26; B31B 50/62; B31B 50/72; B31B 50/73; B31B 50/86

(52) U.S. Cl. CPC B65D 71/0022; B31B 50/262; B31B 50/624; B31B 50/726; B31B 50/73; B65D 2571/0066; B65D 2571/00141; B65D 2571/00376; B65D 2571/0045; B65D 2571/00456; B31B 50/86

(57) ABSTRACT

A carrier for holding a plurality of containers includes a plurality of panels extending at least partially around an interior of the carrier and including a front panel, a back panel, at least one side panel, and a central panel extending from the front panel to the back panel. The central panel includes a reconfigurable lower portion that is positionable between respective bottom portions of adjacent containers of the plurality of containers. The carrier also includes a plurality of end flaps foldably connected to a respective panel of the plurality of panels, the plurality of end flaps are at least partially overlapped to form a closed bottom of the carrier.

### CROSS-REFERENCE TO RELATED APPLICATION

This application claims the benefit of U.S. Provisional Patent Application No. 62/727,695, which was filed on Sep. 6, 2018.

### INCORPORATION BY REFERENCE

The disclosure of U.S. Provisional Patent Application No. 62/727,695, which was filed on Sep. 6, 2018, is hereby incorporated by reference for all purposes as if presented herein in its entirety.

### BACKGROUND OF THE DISCLOSURE

The present disclosure generally relates to carriers for holding articles therein. In particular, the present disclosure is directed to a carrier having a central panel or partition with at least one portion that is reconfigurable upon formation of the carrier.

### SUMMARY OF THE DISCLOSURE

According to one aspect of the disclosure, a carrier for holding a plurality of containers comprises a plurality of panels extending at least partially around an interior of the carrier, the plurality of panels comprising a front panel, a back panel, at least one side panel, and a central panel extending from the front panel to the back panel. The central panel includes a reconfigurable lower portion that is positionable between respective bottom portions of adjacent containers of the plurality of containers. The carrier further comprises a plurality of end flaps foldably connected to a respective panel of the plurality of panels, the plurality of end flaps are at least partially overlapped to form a closed bottom of the carrier.

According to another aspect of the disclosure, a blank for forming a carrier for holding a plurality of containers comprises a plurality of panels for extending at least partially around an interior of the carrier formed from the blank, the plurality of panels comprising a front panel, a back panel, at least one side panel, and a central panel extending from the front panel to the back panel. The central panel includes a reconfigurable lower portion that is positionable between respective bottom portions of adjacent containers of the plurality of containers in the carrier formed from the blank. The blank further comprises a plurality of end flaps foldably connected to a respective panel of the plurality of panels, the plurality of end flaps for being at least partially overlapped to form a closed bottom of the carrier formed from the blank.

According to another aspect of the disclosure, a method of forming a carrier for holding a plurality of containers comprises a obtaining a blank comprising a plurality of panels and a plurality of end flaps foldably connected to a respective panel of the plurality of panels, the plurality of panels comprising a front panel, a back panel, at least one side panel, and a central panel extending from the front panel to the back panel, the central panel includes a reconfigurable lower portion. The method further comprises folding the plurality of panels at least partially around an interior of the carrier, and forming a closed bottom of the carrier by at least partially overlapping the plurality of end flaps. The method further comprises positioning the reconfigurable lower portion of the central panel between respective bottom portions of adjacent containers of the plurality of containers.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a blank for forming a carrier according to an exemplary embodiment of the disclosure.

FIG. 2 is a plan view of a partially folded configuration of the blank of FIG. 1.

FIG. 3 is a plan view of another partially folded configuration of the blank of FIG. 1.

FIG. 4 is a first sequential perspective view of a bottom of a carrier formed from the blank of FIG. 1.

FIG. 5 is a second sequential perspective view of the carrier of FIG. 4.

FIG. 6 is a third sequential perspective view of the carrier of FIG. 4.

FIG. 7 is an enlarged view of an interior portion of the carrier of FIG. 4.

FIG. 8 is a perspective view of the carrier of FIG. 4.

FIG. 9 is a perspective view of the carrier of FIG. 4, similar to FIG. 8, and including hidden lines showing internal elements thereof.

FIG. 10 is a schematic view of the interior of the carrier of FIG. 4.

Corresponding parts may be designated by corresponding reference numbers throughout the drawings.

### DETAILED DESCRIPTION OF THE EXEMPLARY EMBODIMENTS

The present disclosure generally relates to carriers, packages, constructs, sleeves, cartons, or the like, for holding and displaying containers such as jars, bottles, cans, etc. The containers can be used for packaging food and beverage products, for example. The containers can be made from materials suitable in composition for packaging the particular food or beverage item, and the materials include, but are not limited to, glass; plastics such as PET, LDPE, LLDPE, HDPE, PP, PS, PVC, EVOH, and Nylon; and the like; aluminum and/or other metals; or any combination thereof.

Carriers according to the present disclosure can accommodate containers of numerous different shapes. For the purpose of illustration and not for the purpose of limiting the scope of the disclosure, the following detailed description describes beverage containers (e.g., glass bottles) at least partially disposed within the carrier embodiments. In this specification, the terms “lower,” “bottom,” “upper,” “top,” “front,” and “back” indicate orientations determined in relation to fully erected carriers.

As described herein, carriers can be formed by multiple overlapping portions, panels, and/or end flaps. Such portions, panels, and/or end flaps can be designated in relative terms to one another, e.g., “first”, “second”, “third”, etc., in sequential or non-sequential reference, without departing from the disclosure.

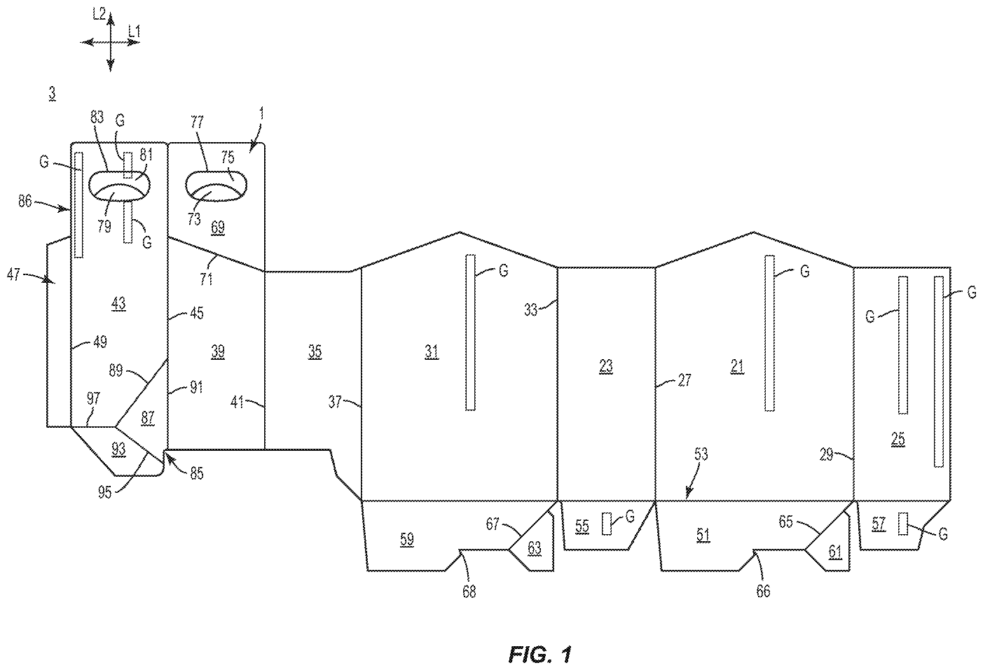

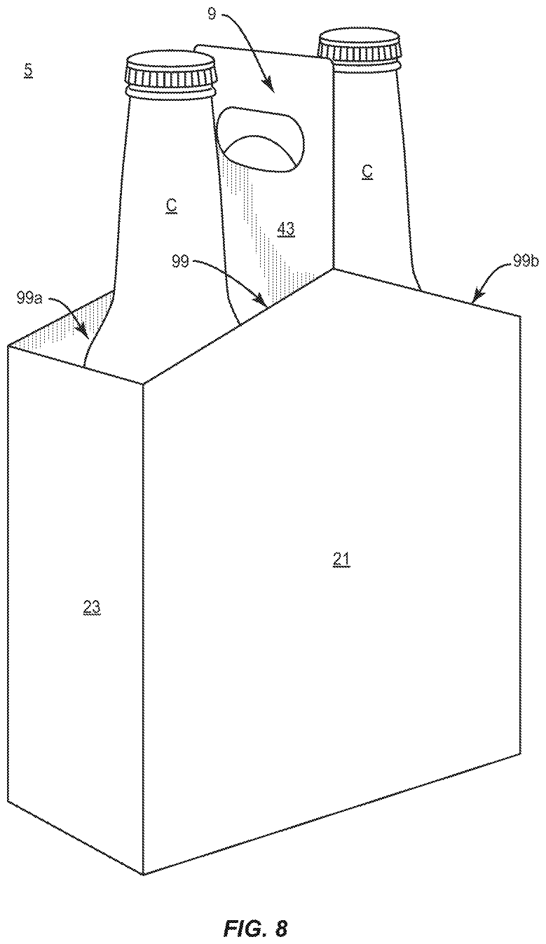

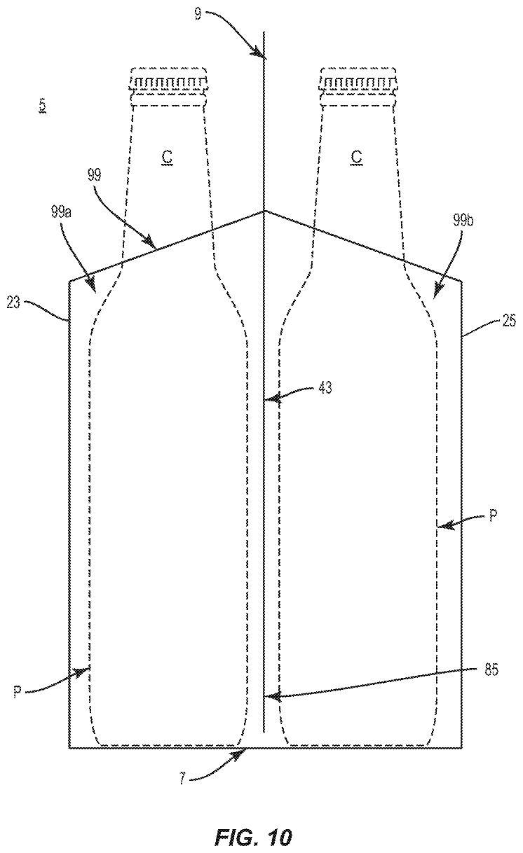

FIG. 1 is a plan view of the exterior side 1 of a blank, generally indicated at 3, that can be obtained and used to form a carton or carrier 5 (FIG. 8) according to a first exemplary embodiment of the disclosure. As described herein, the carrier 5 can include a partition or divider or central panel 43 that is reconfigurable upon formation of the carrier 5 and that is positionable between respective lower portions P (FIG. 10) of adjacent containers C disposed in the carrier 5, e.g., to provide a barrier, buffer, and/or separator therebetween.

As shown in FIG. 1, the blank 3 has a longitudinal axis L1 and a lateral axis L2. The blank 3 comprises a front panel 21 foldably connected to a first side panel 23 and a second side panel 25 at respective lateral fold lines 27, 29. A back panel 31 is foldably connected to the first side panel 23 at a lateral fold line 33. A first reinforcement panel 35, as shown, is foldably connected to the back panel 31 at a lateral fold line 37 and a second reinforcement panel 39 is foldably connected to the first reinforcement panel 35 at a lateral fold line 41. A central panel 43 is foldably connected to the second reinforcement panel 39 at a lateral fold line 45, and an attachment flap 47 is foldably connected to the central panel 43 at a lateral fold line 49.

In the exemplary embodiment shown in FIG. 1, a first bottom end flap 51 is foldably connected to the front panel 21 at a portion of a longitudinal fold line 53, a second bottom end flap 55 is foldably connected to the first side panel 23 at a portion of the longitudinal fold line 53, a third bottom end flap 57 is foldably connected to the second side panel 25 at a portion of the longitudinal fold line 53, and a fourth bottom end flap 59 is foldably connected to the back panel 31 at a portion of the longitudinal fold line 53. As shown, marginal tabs 61, 63 are foldably connected to the respective bottom end flaps 51, 59 at respective oblique fold lines 65, 67. As also shown, the bottom end flaps 51, 59 include locking features in the form of respective notches 66, 68 defined along free edges of the respective bottom end flaps 51, 59, and can facilitate formation of the carrier 5 (FIG. 8), as described further herein.

As also shown in FIG. 1, a handle reinforcement flap 69 is foldably connected to the central panel 43 at a portion of the lateral fold line 45, and is separable from the second reinforcement panel 39 at an oblique cut 71 that extends from the lateral fold line 45 to an end of the fold line 41. The handle reinforcement flap 69 can include a handle opening 73 (broadly, “second handle opening”) and a handle flap 75 (broadly, “second handle flap”) at least partially extending into the handle opening 73 and foldably attached to the handle reinforcement flap 69 at a longitudinal fold line 77.

Still referring to FIG. 1, the central panel 43 includes a handle opening 79 (broadly, “first handle opening”) and a handle flap 81 (broadly, “first handle flap”) at least partially extending into the handle opening 79 and foldably attached to the central panel 43 at a longitudinal fold line 83.

The central panel 43 also includes a lower portion 85 that is flexibly reconfigurable relative to an upper portion 86 of the central panel 43. The lower portion 85 of the central panel 43, as shown, includes an upper reconfigurable panel or reconfigurable panel 87 that is foldably connected to the upper portion 86 of the central panel 43 at an oblique fold line 89 (broadly, “first oblique fold line”) and that is separable from the second reinforcement panel 39 at a cut 91 that extends from an endpoint of the fold line 45 to a free edge of the blank 3. A lower reconfigurable panel or reconfigurable flap 93 is foldably connected to the reconfigurable panel 87 at an oblique fold line 95 (broadly, “second oblique fold line”) and is separable from the upper portion 86 of the central panel 43 at a cut 97 that extends from the intersection of the oblique fold lines 89, 95 to an end of the fold line 49. Alternatively, the cut 97 could be a notch, opening, tear line, or other line of weakening or void without departing from the disclosure.

It will be understood that one or more of the panels 21, 23, 25, 31, 35, 39, 43, 87, the flaps 51, 55, 57, 59, 69, 93, 47, and/or other portions of the blank 3 may be otherwise shaped or configured without departing from the disclosure.

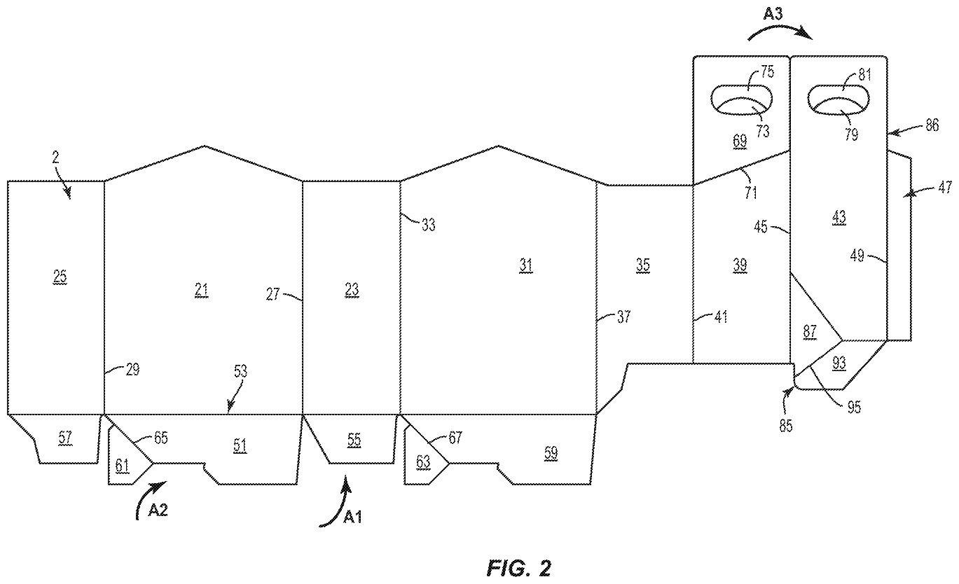

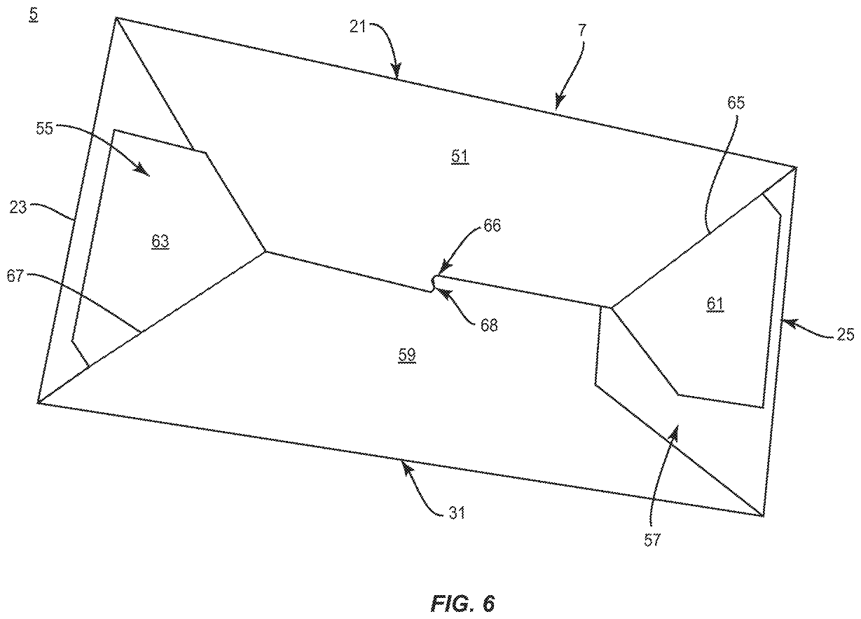

Still referring to FIG. 1, and referring additionally to FIGS. 2-8, formation of the carrier 5 (FIG. 8) from the blank 3 according to one exemplary embodiment of the disclosure will be described. The blank 3 can be positioned with the exterior surface 1 facing down and an interior surface 2 facing up, as shown in FIG. 2. The bottom end flaps 51, 55, 57, 59 can be folded at the respective portions of the fold line 53 in the direction of the arrow Al into at least partial face-to-face contact with the respective panels 21, 23, 25, 31. Thereafter, the marginal tabs 61, 63 can be folded at the respective fold lines 65, 67 in the direction of the arrow A2 into at least partial face-to-face contact with the respective bottom end flaps 51, 61.

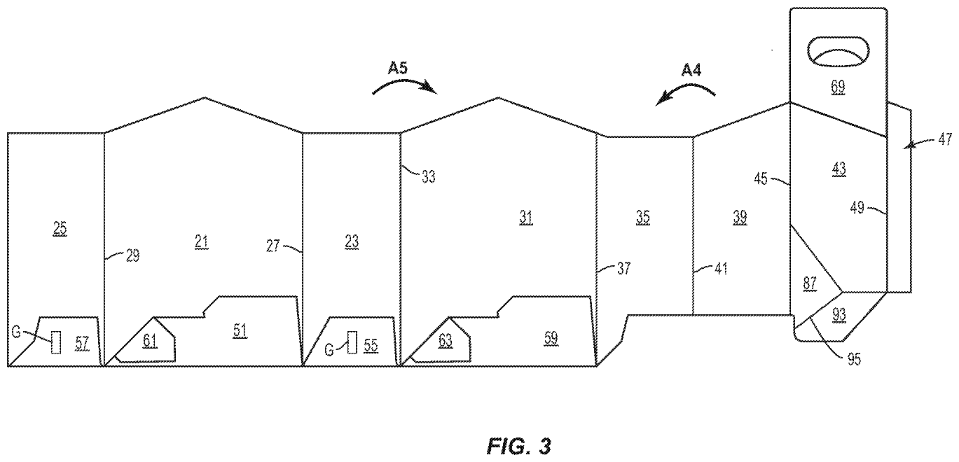

In addition, the handle reinforcement flap 69 can be folded at the respective portion of the fold line 45 in the direction of the arrow A3 into at least partial face-to-face contact with the upper portion 86 of the central panel 43, for example, such that the respective handle openings 73, 79 and handle flaps 75, 81 are aligned to form a handle 9 (FIG. 8). In this regard, at least the upper portion 86 of the central panel 43 extends above the side panels 23, 25 to at least partially form the handle 9 of the carrier 5. Such folded configuration is illustrated in FIG. 3.

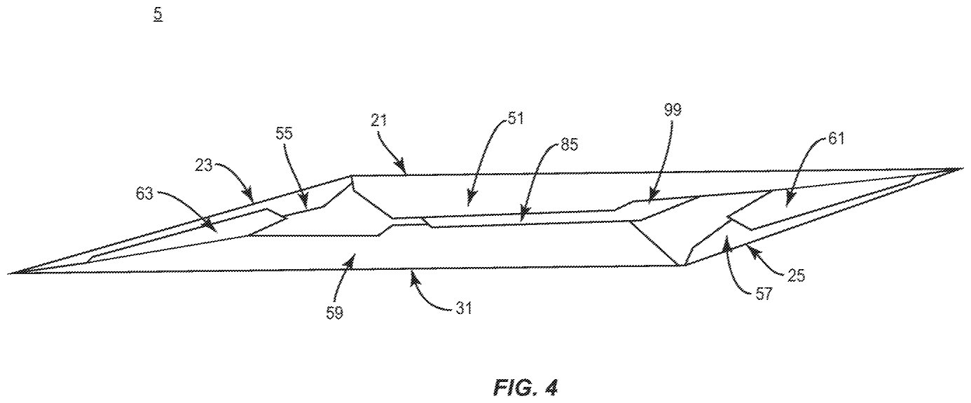

Simultaneously or thereafter, the second reinforcement panel 39 can be folded at the fold line 41 in the direction of the arrow A4 into at least partial face-to-face contact with the first reinforcement panel 35 and such that the central panel 43 and the attachment flap 47 are carried into at least partial face-to-face contact with respective portions of the back panel 31. The first side panel 23 can also be folded at the fold line 33 in the direction of the arrow A5 such that the second side panel 23 is in at least partial face-to-face contact with a portion of the back panel 31 and the attachment flap 47 and such that the front panel 21 is carried into at least partial face-to-face contact with respective portions of the central panel 43 and the second reinforcement panel 39. In such an arrangement, the second side panel 25 can further be folded at the fold line 29 into at least partial face-to-face contact with the first reinforcement panel 35 to form a generally flat, folded configuration of the carrier 5, as illustrated in FIG. 4, in which the panels 21, 23, 25, 31, 35, 39, 43 form an interior 99 of the carrier 5 that is minimized in the flat configuration. Such an arrangement can be maintained with an adhesive such as glue. It will be understood that the carrier 5 can be formed through a different sequence and/or arrangement of folds without departing from the disclosure.

In the flat, folded, or collapsed configuration (broadly, “first configuration”) of the carrier 5 illustrated in FIG. 4, the bottom end flaps 51, 55, 57, 59 are in at least partial face-to-face contact with the respective panels 21, 23, 25, 31, and at least the reconfigurable lower portion 85 of the central panel 43 extends through the interior 99 of the carrier 5 between the bottom end flaps 51, 55, 57, 59, e.g., such that at least the bottom end flaps 51, 59 are in facing relation or at least partial face-to-face contact with a portion of the reconfigurable lower portion 85 of the central panel 43.

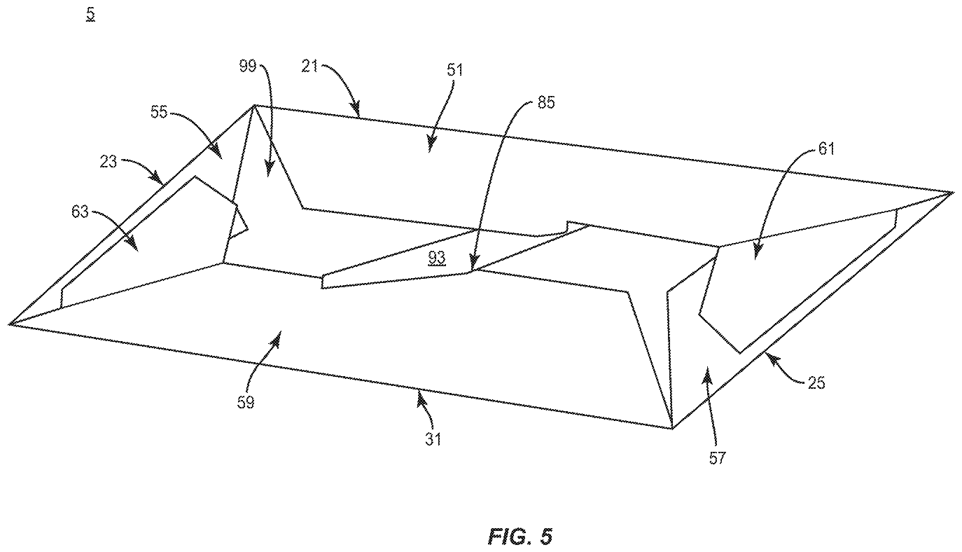

Referring additionally to FIGS. 5, 6, 7, and 8, the carrier 5 is reconfigurable between the collapsed configuration and an erected or expanded configuration (broadly, “second configuration, for example, via urging by manual and/or machine-driven manipulation into an expanded or erected arrangement in which the front and back panels 21, 31 are arranged in spaced, parallel relation and the first and such that the second side panels 23, 25 are arranged in spaced parallel, relation, with the volume of the interior 99 expanded accordingly. In such erected configuration, the first reinforcement panel 35 is in at least partial face-to-face contact with the second side panel 25, the second reinforcement panel 39 is in at least partial face-to-face contact with the front panel 21, and the central panel 43 extends from the front panel 21 to the back panel 31.

Such movement of the panels 21, 23, 25, 31, 35, 39, 43 to the erected configuration causes the end flaps 51, 55, 57, 59 to be urged to fold downwardly, e.g., away from the interior 99 of the carrier 5, at respective portions of the fold line 53 to overlap and form a closed bottom 7 of the carrier 5. The marginal tabs 61, 63 can be coupled, e.g., adhered, to the respective bottom end flaps 57, 59 prior to erection of the carrier 5 such that the bottom end flaps 51, 55, 57, 59 cooperate to together move into an overlapping arrangement, with the notches 66, 68 of the respective bottom end flaps 51, 59 interengaging one another.

In the course of such downward and interengaging movement of the bottom end flaps 51, 55, 57, 59 to form the closed bottom end 7 of the carrier 5, surfaces and edges of the bottom end flaps 51, 55, 57, 59 move past the lower portion 85 of the central panel 43 and converge toward one another. In the course of such slidable contact with the moving bottom end flaps 51, 55, 57, the lower portion 85 of the central panel 43 can reconfigure or reposition, e.g., via movement of the reconfigurable panel 87 and/or the reconfigurable flap 93 at the respective fold lines 89, 95 relative to the upper portion 86 to present a flexible portion of the central panel 43. Accordingly, the lower portion 85 of the central panel 43 is reconfigurable so as to accommodate, e.g., yield so as to not interfere with or obstruct, the convergence and interengagement of the bottom end flaps 51, 55, 57, 59 to form the closed bottom 7 of the carrier 5. In one embodiment, the lower portion 85 of the central panel 43 can be biased toward a substantially straight arrangement, e.g., a substantially coplanar arrangement of the upper portion 86 of the central panel 43, the reconfigurable panel 87, and the reconfigurable flap 93, e.g., via configuration of the fold lines 89, 95.

In one example, the reconfigurable flap 93 and/or the reconfigurable panel 87 can fold out of planar relationship with the upper portion 86 of the central panel 43 during the closing of the bottom of the carrier 5 and can be substantially planar to the upper portion 86 of the central panel 43 after the bottom of the carrier 5 is closed.

The carrier 5 can be formed by other method steps and other folding arrangements or sequences without departing from the disclosure.

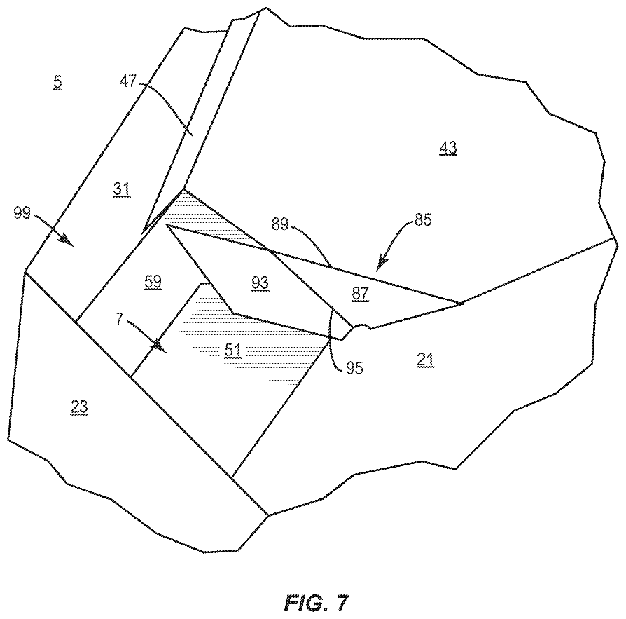

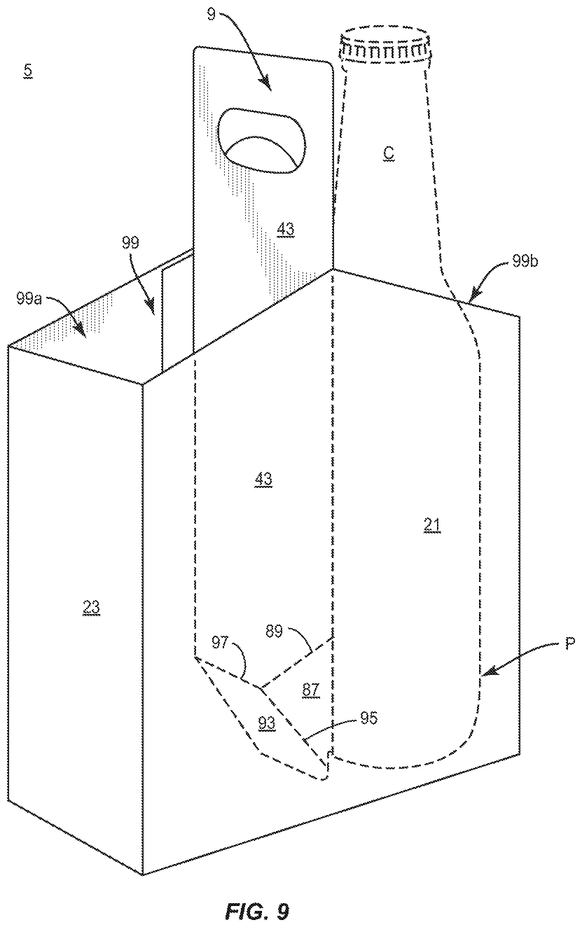

Referring to FIGS. 7-10, in the erected configuration of the carrier 5, the central panel 43 defines and provides a partition or divider between a first interior portion 99a and a second interior portion 99b of the carrier 5, each of which can receive a container C. The lower portion 85 of the central panel 43 extends downwardly from the upper portion 86 of the central panel 43 such that the lower portion 85 of the central panel 43 provides a barrier, buffer, and/or separator between respective lower portions P of the containers C, e.g., to inhibit, minimize, and/or prevent contact between the containers C. In this regard, the lower portion 85 of the central panel 43 can extend downwardly to a point, for example, at which a respective side of the containers C curves toward a respective bottom of the containers C, e.g., an apex of such curves or a point at which the containers C diverge away from the central panel 43.

Such disposition of the lower portion 85 of the central panel 43 between the lower portions P of the containers C can, for example, inhibit, minimize, and/or prevent breakage of the containers C during transport, shipping, and/or storage. In this regard, the upper portion 86 of the central panel 43 can provide a buffer, barrier, and/or separator between upper portions, e.g., shoulders, of the containers C, and the lower portion 85 of the central panel 43 can provide a buffer or barrier between lower portions P of the containers C. The aforementioned placement of the lower portion 85 of the central panel between the lower portion P of the containers C is provided via the reconfiguration of the lower portion 85 during the erection of the carrier 5 as described above.

In this regard, the arrangement of the lower portion 85 of the central panel 43 between the lower portions P of the containers C provides additional structure for separating lower portions P of containers C as compared to, for example, carriers with shorter central panels that avoid contact with bottom flaps during erection of said carriers.

Any of the features of the various embodiments of the disclosure can be combined with, replaced by, or otherwise configured with other features of other embodiments of the disclosure without departing from the scope of this disclosure. Further, the panels, flaps, and/or other features shown and described in conjunction with the blanks could be otherwise shaped, arranged, and/or configured without departing from the disclosure.

The carriers according to the present disclosure can be, for example, formed from blanks of coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carrier to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels, flaps, or features, adhered together by glue during erection of the carrier embodiments. The term “glue” is intended to encompass all manner of adhesives commonly used to secure carrier panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carrier for holding a plurality of containers, comprising:
a plurality of panels extending at least partially around an interior of the carrier, the plurality of panels comprising a front panel, a back panel, at least one side panel, and a central panel extending from the front panel to the back panel, the central panel includes a reconfigurable lower portion that is positionable between respective bottom portions of adjacent containers of the plurality of containers; and
a plurality of end flaps foldably connected to a respective panel of the plurality of panels, the plurality of end flaps are at least partially overlapped to form a closed bottom of the carrier.

2. The carrier of claim 1, wherein the lower portion of the central panel is flexibly reconfigurable relative to an upper portion of the central panel.

3. The carrier of claim 2, wherein the lower portion of the central panel comprises a reconfigurable panel foldably connected to the upper portion of the central panel, and a reconfigurable flap foldably connected to the reconfigurable panel.

4. The carrier of claim 3, wherein the reconfigurable panel is foldably connected to the upper portion of the central panel at a first oblique fold line and the reconfigurable flap is foldably connected to the reconfigurable panel at a second oblique fold line.

5. The carrier of claim 4, wherein the reconfigurable flap is at least partially separable from the upper portion of the central panel at a cut.

6. The carrier of claim 3, wherein the carrier is reconfigurable between a collapsed configuration and an erected configuration, and wherein, in the collapsed configuration, the plurality of end flaps are in at least partial face-to-face contact with the respective panels of the plurality of panels, and the lower portion of the central panel is positioned in at least partial face-to-face contact with at least one end flap of the plurality of end flaps.

7. The carrier of claim 6, wherein the carrier reconfigures from the collapsed configuration to the erected configuration such that one or both of the reconfigurable panel and the reconfigurable flap foldably repositions relative to the upper portion of the central panel as the plurality of end flaps at least partially overlap to form the closed bottom of the carrier.

8. The carrier of claim 7, wherein, in the erected configuration, the lower portion of the central panel is substantially coplanar to an upper portion of the central panel.

9. The carrier of claim 1, wherein the at least one side panel is a first side panel, the plurality of panels further comprises a second side panel, a first reinforcement panel in at least partial face-to-face contact with the front panel, and a second reinforcement panel in at least partial face-to-face contact with the second side panel.

10. The carrier of claim 9, wherein the lower portion of the central panel comprises a reconfigurable panel and a reconfigurable flap foldably connected to the reconfigurable panel.

11. The carrier of claim 10, wherein the reconfigurable panel is foldably connected to an upper portion of the central panel, the upper portion of the central panel extends above the front panel and the back panel to form a handle of the carrier.

12. The carrier of claim 11, wherein the plurality of end flaps comprises locking features for maintaining the closed bottom of the carrier.

13. The carrier of claim 12, wherein the locking features comprise a notch on at least two end flaps of the plurality of end flaps, the respective notches configured to interengage one another.

14. A blank for forming a carrier for holding a plurality of containers, comprising:
a plurality of panels for extending at least partially around an interior of the carrier formed from the blank, the plurality of panels comprising a front panel, a back panel, at least one side panel, and a central panel extending from the front panel to the back panel, the central panel includes a reconfigurable lower portion that is positionable between respective bottom portions of adjacent containers of the plurality of containers in the carrier formed from the blank; and
a plurality of end flaps foldably connected to a respective panel of the plurality of panels, the plurality of end flaps for being at least partially overlapped to form a closed bottom of the carrier formed from the blank.

15. The blank of claim 14, wherein the lower portion of the central panel is flexibly reconfigurable relative to an upper portion of the central panel.

16. The blank of claim 15, wherein the lower portion of the central panel comprises a reconfigurable panel foldably connected to the upper portion of the central panel, and a reconfigurable flap foldably connected to the reconfigurable panel.

17. The blank of claim 16, wherein the reconfigurable panel is foldably connected to the upper portion of the central panel at a first oblique fold line and the reconfigurable flap is foldably connected to the reconfigurable panel at a second oblique fold line.

18. The blank of claim 17, wherein the reconfigurable flap is at least partially separable from the upper portion of the central panel at a cut.

19. The blank of claim 14, wherein the at least one side panel is a first side panel, the plurality of panels further comprises a second side panel, a first reinforcement panel for being positioned in at least partial face-to-face contact with the front panel when the carrier is formed from the blank, and a second reinforcement panel for being positioned in at least partial face-to-face contact with the second side panel when the carrier is formed from the blank.

20. The blank of claim 19, wherein the lower portion of the central panel comprises a reconfigurable panel and a reconfigurable flap foldably connected to the reconfigurable panel.

21. The blank of claim 20, wherein the reconfigurable panel is foldably connected to an upper portion of the central panel, the upper portion of the central panel extends above the front panel and the back panel.

22. The blank of claim 21, wherein the plurality of end flaps comprises locking features for maintaining the closed bottom of the carrier formed from the blank.

23. The blank of claim 22, wherein the locking features comprise a notch on at least two end flaps of the plurality of end flaps, the respective notches configured to interengage one another.

24. A method of forming a carrier for holding a plurality of containers, comprising:
a obtaining a blank comprising a plurality of panels and a plurality of end flaps foldably connected to a respective panel of the plurality of panels, the plurality of panels comprising a front panel, a back panel, at least one side panel, and a central panel extending from the front panel to the back panel, the central panel includes a reconfigurable lower portion;
folding the plurality of panels at least partially around an interior of the carrier;
forming a closed bottom of the carrier by at least partially overlapping the plurality of end flaps; and
positioning the reconfigurable lower portion of the central panel between respective bottom portions of adjacent containers of the plurality of containers.

25. The method of claim 24, wherein the lower portion of the central panel is flexibly reconfigurable relative to an upper portion of the central panel.

26. The method of claim 25, wherein the lower portion of the central panel comprises a reconfigurable panel foldably connected to the upper portion of the central panel, and a reconfigurable flap foldably connected to the reconfigurable panel.

27. The method of claim 26, wherein the reconfigurable panel is foldably connected to the upper portion of the central panel at a first oblique fold line and the reconfigurable flap is foldably connected to the reconfigurable panel at a second oblique fold line.

28. The method of claim 27, wherein the reconfigurable flap is at least partially separable from the upper portion of the central panel at a cut.

29. The method of claim 26, wherein the carrier is reconfigurable between a collapsed configuration and an erected configuration, and wherein, in the collapsed configuration, the plurality of end flaps are in at least partial face-to-face contact with the respective panels of the plurality of panels, and the lower portion of the central panel is positioned in at least partial face-to-face contact with at least one end flap of the plurality of end flaps.

30. The method of claim 29, wherein the carrier reconfigures from the collapsed configuration to the erected configuration such that one or both of the reconfigurable panel and the reconfigurable flap foldably repositions relative to the upper portion of the central panel as the plurality of end flaps at least partially overlap to form the closed bottom of the carrier.

31. The method of claim 30, wherein, in the erected configuration, the lower portion of the central panel is substantially coplanar to an upper portion of the central panel.

32. The method of claim 24, wherein the at least one side panel is a first side panel, the plurality of panels further comprises a second side panel, a first reinforcement panel in at least partial face-to-face contact with the front panel, and a second reinforcement panel in at least partial face-to-face contact with the second side panel.

33. The method of claim 32, wherein the lower portion of the central panel comprises a reconfigurable panel and a reconfigurable flap foldably connected to the reconfigurable panel.

34. The method of claim 33, wherein the reconfigurable panel is foldably connected to an upper portion of the central panel, the upper portion of the central panel extends above the front panel and the back panel to form a handle of the carrier.

35. The method of claim 34, wherein the plurality of end flaps comprises locking features for maintaining the closed bottom of the carrier.

36. The method of claim 35, wherein the locking features comprise a notch on at least two end flaps of the plurality of end flaps, the respective notches interengage one another when the closed bottom is formed.
